(19) United States
(12) Patent Application Publication
(10) Pub. No.: US 2026/0038727 A1
(43) Pub. Date: Feb. 5, 2026

(54) TRANSFORMER AND MANUFACTURING METHOD THEREOF

(71) Applicant: APACECORE PTE. LTD., Hsinchu County (TW)

(72) Inventor: Chen Zhang, Hsinchu County (TW)

(73) Assignee: APACECORE PTE. LTD., Hsinchu County (TW)

(21) Appl. No.: 19/271,713

(22) Filed: Jul. 16, 2025

(30) Foreign Application Priority Data
Aug. 5, 2024 (TW) 113129132

(51) Int. Cl. H01F 27/28; H01F 19/00; H01F 27/245; H01F 27/32; H01F 41/00; H01F 41/04

(52) U.S. Cl. CPC H01F 27/2804; H01F 19/00; H01F 27/245; H01F 27/2895; H01F 27/327; H01F 41/005; H01F 41/041; H01F 2027/2809

(57) ABSTRACT

A transformer and a manufacturing method thereof are provided. The transformer includes a bottom structure, a top structure, and a middle structure. The bottom structure includes a bottom circuit layer embedded in a bottom insulating layer. The top structure is disposed over the bottom structure and includes a top circuit layer embedded in a top insulating layer. The middle structure is disposed between the bottom structure and the top structure and includes an insulating layer, ring-shaped metal layers, and conductive pillars. The ring-shaped metal layers are stacked in a first direction in the insulating layer. The conductive pillars are disposed in the insulating layer and on an inner side and an outer side of the stacked ring-shaped metal layers. The insulating layer electrically isolates the conductive pillars from the ring-shaped metal layers. The top circuit layer and the bottom circuit layer are electrically connected through the conductive pillars.

### CROSS-REFERENCE TO RELATED APPLICATION

This application claims the priority benefit of Taiwan application serial no. 113129132, filed on Aug. 5, 2024. The entirety of the above-mentioned patent application is hereby incorporated by reference herein and made a part of this specification.

### BACKGROUND

### Technical Field

The disclosure relates to an electronic element and a manufacturing method thereof, and in particular to a transformer and a manufacturing method thereof.

### Description of Related Art

Generally speaking, a transformer is composed of an iron core and two independent coils. The iron core is, for example, formed by stacking multiple ring-shaped iron sheets. The two coils are composed of enameled wires respectively surrounding two opposite sides of the iron core, which respectively serve as a primary side and a secondary side to achieve voltage conversion under the action of alternating current based on the principle of electromagnetic induction. However, the size of the traditional transformer is large and heavy, which is difficult to shrink, causing applications to be limited.

### SUMMARY

The disclosure provides a transformer that has a reduced size and is easy to manufacture and a manufacturing method thereof.

A manufacturing method of a transformer of the disclosure includes the following steps. Multiple middle layers are formed. Each of the middle layers includes an insulating layer, an ring-shaped metal layer, and multiple vertical connectors. The ring-shaped metal layer is embedded in the insulating layer. The vertical connectors are disposed in the insulating layer and are disposed along an inner side and an outer side of the ring-shaped metal layer. The insulating layer electrically isolates the vertical connectors from the ring-shaped metal layer. A top structure is formed. The top structure includes a top circuit layer embedded in a top insulating layer. A bottom structure is formed. The bottom structure includes a bottom circuit layer embedded in a bottom insulating layer. The bottom structure, the middle layers, and the top structure are sequentially stacked in a first direction, so that the middle layers are located between the bottom structure and the top structure. The ring-shaped metal layers of the middle layers overlap with each other, and the vertical connectors of the middle layers overlap with each other. The bottom structure, the middle layers, and the top structure are bonded. The top circuit layer and the bottom circuit layer are electrically connected to each other through the vertical connectors of the middle layers.

In an embodiment of the disclosure, the vertical connectors of each of the middle layers include multiple first vertical connectors and multiple second vertical connectors. The first vertical connectors are located in the insulating layer and are disposed in pairs on two sides of a first side of the ring-shaped metal layer. The second vertical connectors are located in the insulating layer and are disposed in pairs on two sides of a second side of the ring-shaped metal layer. The second side is opposite to the first side.

In an embodiment of the disclosure, the top circuit layer of the top structure includes multiple first top circuit patterns and multiple second top circuit patterns, and the bottom circuit layer of the bottom structure includes multiple first bottom circuit patterns and multiple second bottom circuit patterns. When sequentially stacking the bottom structure, the middle layers, and the top structure, the first top circuit patterns and the first bottom circuit patterns correspond to the first side of the ring-shaped metal layer, and the second top circuit patterns pattern and the second bottom circuit patterns correspond to the second side of the ring-shaped metal layer.

In an embodiment of the disclosure, the first vertical connectors of each of the middle layers correspond to the two ends of each of the first bottom circuit patterns, and the second vertical connectors of each of the middle layers correspond to two ends of each of the second bottom circuit patterns.

In an embodiment of the disclosure, the first top circuit patterns and the first bottom circuit patterns are electrically connected to each other through the first vertical connectors of the middle layers to form a first conductive path that surrounds along the first side of the ring-shaped metal layer, and the second top circuit patterns and the second bottom circuit patterns are electrically connected to each other through the second vertical connectors of the middle layers to form a second conductive path that surrounds along the second side of the ring-shaped metal layer.

In an embodiment of the disclosure, when sequentially stacking the bottom structure, the middle layers, and the top structure, a first end of an N^{th} first top circuit pattern arranged in a second direction corresponds to a first end of a (N+1)^{th} first bottom circuit pattern arranged in the second direction, and a second end of the N^{th} first top circuit pattern arranged in the second direction corresponds to a second end of an N^{th} first bottom circuit pattern arranged in the second direction. The first end refers to an end close to the outer side of the ring-shaped metal layer, the second end refers to an end close to the inner side of the ring-shaped metal layer, and N is a positive integer.

In an embodiment of the disclosure, the step of forming each of the middle layers includes the following steps. A first insulating layer is formed. The first insulating layer has multiple first openings. The ring-shaped metal layer is formed over the first insulating layer. The vertical connectors are formed over the first insulating layer and in the first openings. A second insulating layer is formed on the ring-shaped metal layer and the vertical connectors to cover top surfaces of the ring-shaped metal layer and the vertical connectors. The first insulating layer and the second insulating layer form the insulating layer. Multiple second openings are formed in the second insulating layer to expose the vertical connectors.

In an embodiment of the disclosure, the step of forming the top structure includes the following steps. A first top insulating layer is formed. The first top insulating layer has multiple top openings. A conductive material layer is formed over the first top insulating layer. The conductive material layer is patterned to form the top circuit layer over the first top insulating layer and in the top openings. The top circuit layer includes a top circuit pattern located over the first top insulating layer and multiple top contacts located in the top openings, and the top contacts correspond to two ends of the top circuit pattern. A second top insulating layer is formed on the top circuit layer.

In an embodiment of the disclosure, the step of forming the bottom structure includes the following steps. A first bottom insulating layer is formed. A conductive material layer is formed over the first bottom insulating layer. The conductive material layer is patterned to form the bottom circuit layer over the first bottom insulating layer. The bottom circuit layer includes multiple bottom circuit patterns. A second bottom insulating layer is formed on the bottom circuit layer. Multiple bottom openings are formed in the second bottom insulating layer to expose two ends of each of the bottom circuit patterns.

In an embodiment of the disclosure, a method of bonding the bottom structure, the middle layers, and the top structure includes the following steps. The vertical connectors corresponding to the adjacent middle layers are bonded and electrically connected through a first conductive connector. The bottom circuit layer of the bottom structure and the vertical connectors corresponding to a bottommost layer among the middle layers are bonded and electrically connected through a second conductive connector. The top circuit layer of the top structure and the vertical connectors corresponding to a topmost layer among the middle layers are bonded and electrically connected through a third conductive connector.

In an embodiment of the disclosure, the first conductive connector, the second conductive connector, and the third conductive connector include solder balls or micro bumps.

In an embodiment of the disclosure, after bonding the bottom structure, the middle layers, and the top structure, the vertical connectors of a bottommost layer among the middle layers extend through a part of the bottom insulating layer of the bottom structure to be physically and electrically connected to the bottom circuit layer of the bottom structure.

In an embodiment of the disclosure, after bonding the bottom structure, the middle layers, and the top structure, a part of the top circuit layer of the top structure extends through the insulating layer of a topmost layer among the middle layers to be physically and electrically connected to the vertical connectors of the topmost layer among the middle layers.

A transformer of the disclosure includes a bottom structure, a top structure, and a middle structure. The bottom structure includes a bottom circuit layer embedded in a bottom insulating layer. The top structure is disposed over the bottom structure. The top structure includes a top circuit layer embedded in a top insulating layer. The middle structure is disposed between the bottom structure and the top structure. The middle structure includes an insulating layer, multiple ring-shaped metal layers, and multiple conductive pillars. The ring-shaped metal layers are stacked on each other in a first direction and are disposed in the insulating layer. The conductive pillars are disposed in the insulating layer and are disposed on an inner side and an outer side of the stacked ring-shaped metal layers. The insulating layer electrically isolates the conductive pillars from the ring-shaped metal layers. The top circuit layer and the bottom circuit layer are electrically connected through the conductive pillars of the middle structure.

In an embodiment of the disclosure, the conductive pillars include multiple first conductive pillars and multiple second conductive pillars. The first conductive pillars are located in the insulating layer and are disposed in pairs on two sides of a first side of the stacked ring-shaped metal layers. The second conductive pillars are located in the insulating layer and are disposed in pairs on two sides of a second side of the stacked ring-shaped metal layers. The second side is opposite to the first side.

In an embodiment of the disclosure, the top circuit layer of the top structure includes multiple first top circuit patterns and multiple second top circuit patterns, and the bottom circuit layer of the bottom structure includes multiple first bottom circuit patterns and multiple second bottom circuit patterns. The first top circuit patterns and the first bottom circuit patterns correspond to the first side of the stacked ring-shaped metal layers, and the second top circuit patterns and the second bottom circuit patterns correspond to the second side of the stacked ring-shaped metal layers.

In an embodiment of the disclosure, orthographic projections of the first top circuit patterns in the first direction and orthographic projections of the first bottom circuit patterns in the first direction are staggered along a second direction.

In an embodiment of the disclosure, the first top circuit patterns and the first bottom circuit patterns are electrically connected to each other through the first conductive pillars of the middle structure to form a first conductive path that surrounds along the first side of the stacked ring-shaped metal layer, and the second top circuit patterns and the second bottom circuit patterns are electrically connected to each other through the second conductive pillars of the middle structure to form a second conductive path that surrounds along the second side of the stacked ring-shaped metal layers.

In an embodiment of the disclosure, each of the conductive pillars includes vertical connectors and conductive connectors staggered and stacked in the first direction, and a material of the vertical connector is different from a material of the conductive connector.

In an embodiment of the disclosure, the material of the vertical connector is the same material as a material of the ring-shaped metal layers.

Based on the above, the transformer of the disclosure is manufactured through the semiconductor manufacturing method, which can effectively reduce the size thereof to form an ultra-thin transformer, thereby facilitating application in small-sized products. In addition, the transformer of the disclosure may be easily integrated together with a semiconductor device, which can be efficiently applied in terms of process flow and space.

### BRIEF DESCRIPTION OF THE DRAWINGS

FIG. 1A is a schematic three-dimensional view of a transformer according to an embodiment of the disclosure.

FIG. 1B is a schematic cross-sectional view of a transformer according to an embodiment of the disclosure.

FIG. 1C is a schematic top view of a middle structure of a transformer according to an embodiment of the disclosure.

FIG. 1D is a schematic top view of a bottom structure of a transformer according to an embodiment of the disclosure.

FIG. 1E is a schematic orthographic view of a first wire structure and a second wire structure of a transformer in a first direction according to an embodiment of the disclosure.

FIG. 2A to FIG. 2E are schematic cross-sectional views of a manufacturing process of a middle structure according to an embodiment of the disclosure.

FIG. 3A to FIG. 3C are schematic cross-sectional views of a manufacturing process of a top structure according to an embodiment of the disclosure.

FIG. 4A and FIG. 4B are schematic cross-sectional views of a manufacturing process of a bottom structure according to an embodiment of the disclosure.

FIG. 5A to FIG. 5B are schematic cross-sectional views of a manufacturing process of a transformer according to an embodiment of the disclosure.

FIG. 6A to FIG. 6F are schematic cross-sectional views of a manufacturing process of a transformer according to an embodiment of the disclosure.

### DESCRIPTION OF THE EMBODIMENTS

In the drawings, the thicknesses of layers, films, panels, regions, etc., are exaggerated for clarity. Throughout the specification, the same reference numerals refer to the same elements. It should be understood that when an element such as a layer, film, region, or substrate is referred to as being “on” or “connected to” another element, the element may be directly on or connected to the other element or there may also be a middle element. In contrast, when an element is referred to as being “directly on” or “directly connected to” another element, there is no middle element. As used herein, “connection” may refer to physical and/or electrical connection. Furthermore, “electrical connection” or “coupling” may include the presence of another element between two elements.

It should be understood that although terms such as “first” and “second” may be used herein to describe various elements, components, regions, layers, and/or parts, the elements, components, regions, layers, and/or parts should not be limited by the terms. The terms are only used to distinguish one element, component, region, layer, or part from another element, component, region, layer, or part. Thus, a “first element”, “component”, “region”, “layer”, or “part” discussed below may be referred to as a second element, component, region, layer, or part without departing from the teachings herein.

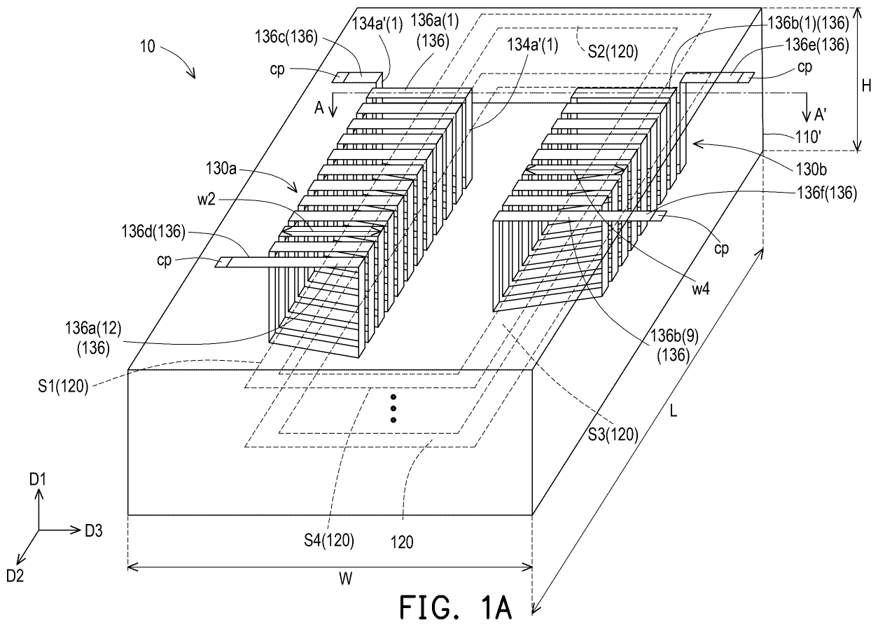

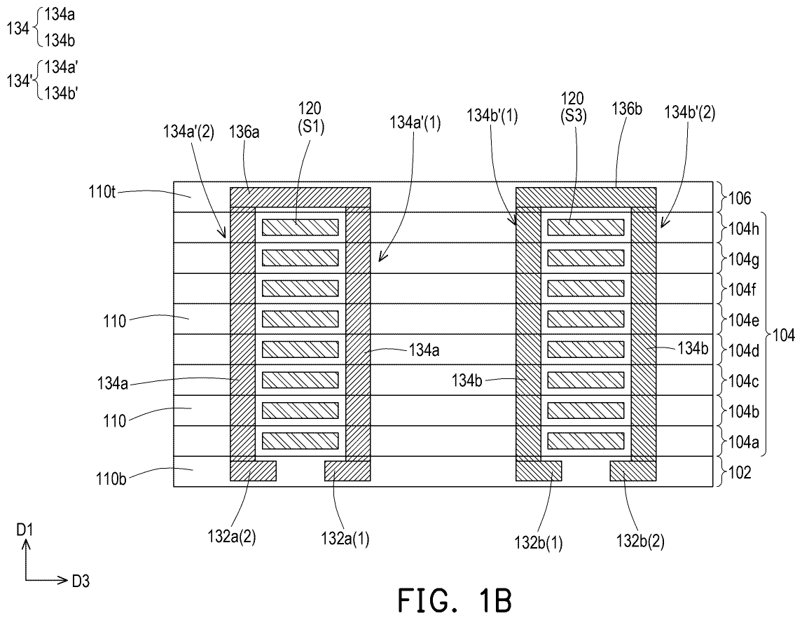

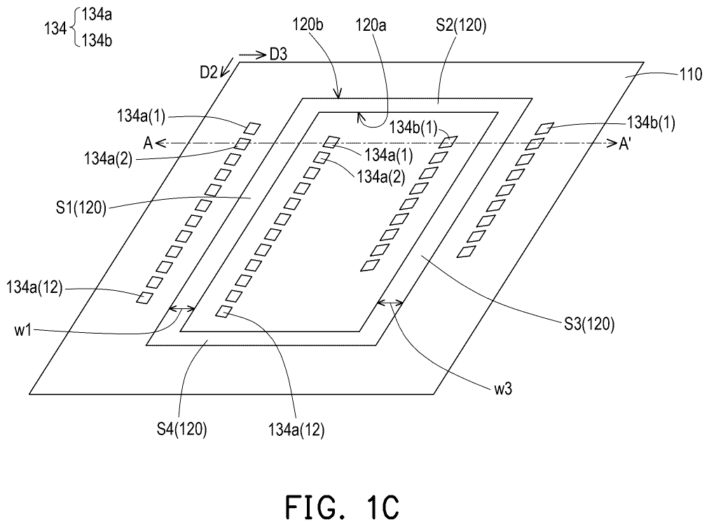

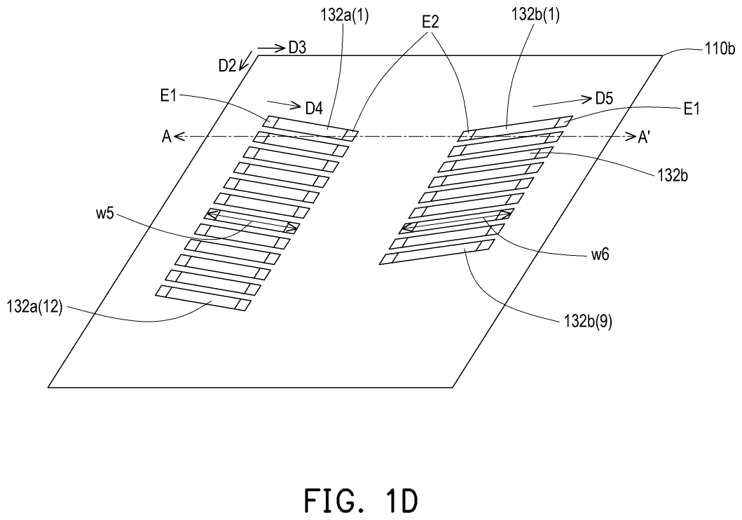

FIG. 1A is a schematic three-dimensional view of a transformer 10 according to an embodiment of the disclosure. FIG. 1B is a schematic cross-sectional view of the transformer 10 according to an embodiment of the disclosure. FIG. 1C is a schematic top view of a middle structure 104 of the transformer 10 according to an embodiment of the disclosure. FIG. 1D is a schematic top view of a bottom structure 102 of the transformer 10 according to an embodiment of the disclosure. FIG. 1E is a schematic orthographic view of a first wire structure 130a and a second wire structure 130b of the transformer 10 in a first direction D1 according to an embodiment of the disclosure. FIG. 1B may be a schematic cross-sectional view along a sectional line A-A′ of FIG. 1A. For clarity of illustration, FIG. 1A, FIG. 1C, and FIG. 1D are shown in perspective. Only two ring-shaped metal layers 120 shown with dotted lines are illustrated as representatives and other ring-shaped metal layers are omitted in FIG. 1A for convenience of illustration.

Please refer to FIG. 1A to FIG. 1D. The transformer 10 includes the bottom structure 102, the middle structure 104, and a top structure 106. The bottom structure 102 includes a bottom circuit layer 132 embedded in a bottom insulating layer 110b. The top structure 106 is disposed over the bottom structure 102, and the top structure 106 includes a top circuit layer 136 embedded in a top insulating layer 110t. The middle structure 104 is disposed between the bottom structure 102 and the top structure 106. The middle structure 104 may include multiple middle layers (for example, middle layers 104a to 104h) sequentially stacked on the bottom structure 102 in the first direction D1. FIG. 1B schematically shows 8 middle layers, which is not intended to limit the disclosure. The number of middle layers may be one or more and may be adjusted according to actual requirements.

The middle layers 104a to 104h basically have the same structure and configuration. For example, each of the middle layers 104a to 104h includes an insulating layer 110, an ring-shaped metal layer 120, and multiple vertical connectors 134. The ring-shaped metal layer 120 is embedded in the insulating layer 110, and the vertical connectors 134 are disposed in the insulating layer 110 and are disposed along an inner side 120a and an outer side 120b of the ring-shaped metal layer 120. The insulating layer 110 may electrically isolate the vertical connectors 134 from the ring-shaped metal layer 120. In some embodiments, the ring-shaped metal layer 120 may be a closed ring shape. The closed ring shape may include, for example, a rectangular ring, a circular ring, an elliptical ring, or other suitable shapes, and the disclosure is not limited thereto. In an embodiment in which the ring-shaped metal layer 120 is a rectangular ring, as shown in FIG. 1A, the ring-shaped metal layer 120 is composed of four sides S1, S2, S3, and S4. The sides S1, S2, S3, and S4 are sequentially connected to form a rectangle. The side S1 and the side S3, for example, extend in a second direction D2 and are opposite to each other. The side S2 and the side S4, for example, extend in a third direction D3 and are opposite to each other. The first direction D1, the second direction D2, and the third direction D3 are perpendicular to each other. In some embodiments, the vertical connectors 134 may include multiple first vertical connectors 134a and multiple second vertical connectors 134b. The first vertical connectors 134a are disposed in pairs on two sides of the side S1 of the ring-shaped metal layer 120 in the second direction D2. The second vertical connectors 134b are disposed in pairs on two sides of the side S3 of the ring-shaped metal layer 120 in the second direction D2. Specifically, 12 pairs of the first vertical connectors 134a sequentially arranged along the second direction D2 and 9 pairs of the second vertical connectors 134b sequentially arranged along the second direction D2 are shown in FIG. 1C, wherein (n) after a numeral of a vertical connector represents the sequence of a pair of the vertical connectors along an arrangement direction (for example, the second direction D2, etc.) (where n is a positive integer). For example, 134a(1) represents the first pair of first vertical connectors, 134a(2) represents the second pair of first vertical connectors, and so on. One of each pair of the first vertical connectors 134a is arranged on an inner side of the side S1 of the ring-shaped metal layer 120 (also referred to as an inner vertical connector), and the other one of each pair of the first vertical connectors 134a is arranged on an outer side of the side S1 of the ring-shaped metal layer 120 (also referred to as an outer vertical connector). Similarly, one of each pair of the second vertical connectors 134b is arranged on an inner side of the side S3 of the ring-shaped metal layer 120 (also referred to as an inner vertical connector), and the other one of each pair of the second vertical connectors 134b is arranged on an outer side of the side S3 of the ring-shaped metal layer 120 (also referred to as an outer vertical connector). It should be understood that FIG. 1C only schematically illustrates multiple first vertical connectors 134a and multiple second vertical connectors 134b, which is not intended to limit the disclosure. The number of the first vertical connectors 134a and the number of the second vertical connectors 134b may be adjusted according to actual requirements.

In some embodiments, the number of pairs of first vertical connectors is different from the number of pairs of second vertical connectors. In the embodiment, the number of pairs of first vertical connectors is greater than the number of pairs of second vertical connectors, but the disclosure is not limited thereto. In other embodiments, the number of pairs of first vertical connectors may be less than the number of pairs of second vertical connectors.

In some embodiments, the ring-shaped metal layer 120 of each of the middle layers 104a to 104h (for example, the middle layer 104a) and the ring-shaped metal layer 120 of an adjacent middle layer (for example, the middle layer 104b) are arranged in the first direction D1 and overlap, and the vertical connectors 134 of each of the middle layers 104a to 104h (for example, the middle layer 104a) and the vertical connectors 134 of the adjacent middle layer (for example, the middle layer 104b) are arranged in the first direction D1 and overlap. In some embodiments, the vertical connectors 134 from different middle layers arranged in the first direction D1 and overlapping are electrically connected to each other to form multiple conductive pillars 134′, as shown in FIG. 1B. In other words, each conductive pillar 134′ may include one vertical connector 134 of each of the middle layers 104a to 104h. The conductive pillar 134′ may be divided into a first conductive pillar 134a′ and a second conductive pillar 134b′. The first conductive pillars 134a′ may, for example, correspond to the first vertical connectors 134a arranged in the first direction D1 and electrically connected to each other. The second conductive pillars 134b′ may, for example, correspond to the second vertical connectors 134b arranged in the first direction D1 and electrically connected to each other. In other words, the first conductive pillars 134a′ may be disposed in pairs on the two sides of the side S1 of the stacked ring-shaped metal layers 120 along the second direction D2, and the second conductive pillars 134b′ may be disposed in pairs on the two sides of the side S3 of the stacked ring-shaped metal layers 120 along the second direction D2. In other words, the middle structure 104 may include the ring-shaped metal layers 120 and the conductive pillars 134′ located in the insulating layer 110. The conductive pillars 134′ are disposed on an inner side and an outer side of the stacked ring-shaped metal layers 120 and are electrically isolated from the stacked ring-shaped metal layers 120.

In some embodiments, the number of the first conductive pillars 134a′ is different from the number of the second conductive pillars 134b′. FIG. 1A schematically illustrates 12 pairs of the first conductive pillars 134a′ and 9 pairs of the second conductive pillars 134b′, which is not intended to limit the disclosure. The number of the first conductive pillars 134a′ and the number of the second conductive pillars 134b′ may be adjusted according to actual requirements. The number of the first conductive pillars 134a′ may be greater or less than the number of the second conductive pillars 134b′. In FIG. 1A to FIG. 1E, (n) after a numeral of a conductive pillar represents the sequence of a pair of the conductive pillars along an arrangement direction (for example, the second direction D2, etc.) (where n is a positive integer). For example, 134a′(1) represents the first pair of first conductive pillars, 134b′(1) represents the first pair of second conductive pillars, and so on.

The top circuit layer 136 of the top structure 106 and the bottom circuit layer 132 of the bottom structure 102 are electrically connected through the conductive pillars 134′ (or the vertical connectors 134) of the middle structure 104.

In some embodiments, the top circuit layer 136 includes multiple first top circuit patterns 136a and multiple second top circuit patterns 136b. The first top circuit patterns 136a are, for example, multiple line segments arranged in the second direction D2 and extending in the third direction D3. Each of the first top circuit patterns 136a spans the side S1 of the stacked ring-shaped metal layers 120 in the third direction D3. In other words, a width w2 of the first top circuit pattern 136a in the third direction D3 is greater than a width w1 of the side S1 of the ring-shaped metal layer 120 in the third direction D3. The second top circuit patterns 136b are, for example, multiple line segments arranged in the second direction D2 and extending in the third direction D3. Each of the second top circuit patterns 136b spans the side S3 of the stacked ring-shaped metal layers 120 in the third direction D3. In other words, a width w4 of the second top circuit pattern 136b in the third direction D3 is greater than a width w3 of the side S3 of the ring-shaped metal layer 120 in the third direction D3. The first top circuit pattern 136a and the second top circuit pattern 136b may be collectively referred to as a top circuit pattern.

In some embodiments, the number of the first top circuit patterns 136a is different from the number of the second top circuit patterns 136b. FIG. 1A schematically illustrates 12 first top circuit patterns 136a and 9 second top circuit patterns 136b, which is not intended to limit the disclosure. The number of the first top circuit patterns 136a and the number of the second top circuit patterns 136b may be adjusted according to actual requirements. In FIG. 1A to FIG. 1E, (n) after a numeral of a top circuit pattern represents the sequence of the top circuit pattern along an arrangement direction (for example, the second direction D2, etc.) (where n is a positive integer). For example, 136a(1) represents the first first top circuit pattern, 136b(1) represents the first second top circuit pattern, and so on.

In some embodiments, the bottom circuit layer 132 includes multiple first bottom circuit patterns 132a and multiple second bottom circuit patterns 132b. The first bottom circuit patterns 132a are, for example, multiple line segments arranged in the second direction D2 and extending in a fourth direction D4. Each of the first bottom circuit patterns 132a spans the side S1 of the stacked ring-shaped metal layers 120 in the fourth direction D4. In other words, a width w5 of the first bottom circuit pattern 132a in the fourth direction D4 is greater than the width w1 of the side S1 of the ring-shaped metal layer 120 in the third direction D3. The fourth direction D4 intersects, but is not perpendicular to, the third direction D3 and the second direction D2, and the fourth direction D4 is perpendicular to the first direction D1. The second bottom circuit patterns 132b are, for example, multiple line segments arranged in the second direction D2 and extending in a fifth direction D5. Each of the second bottom circuit patterns 132b spans the side S3 of the stacked ring-shaped metal layers 120 in the fifth direction D5. In other words, a width w6 of the second bottom circuit pattern 132b in the fifth direction D5 is greater than the width w3 of the side S3 of the ring-shaped metal layer 120 in the third direction D3. The fifth direction D5 intersects, but is not perpendicular to, the third direction D3 and the second direction D2, and the fifth direction D5 is perpendicular to the first direction D1. The fourth direction D4 may be the same as or different from the fifth direction D5.

In some embodiments, the number of the first bottom circuit patterns 132a is different from the number of the second bottom circuit patterns 132b. FIG. 1A schematically illustrates 12 first bottom circuit patterns 132a and 9 second bottom circuit patterns 132b, which is not intended to limit the disclosure. The number of the first bottom circuit patterns 132a and the number of the second bottom circuit patterns 132b may be adjusted according to actual requirements. In FIG. 1A to FIG. 1E, (n) after a numeral of a bottom circuit pattern represents the sequence of the bottom circuit pattern along an arrangement orientation (for example, the second direction D2, etc.) (where n is a positive integer). For example, 132a(1) represents the first first bottom circuit pattern, 132a(2) represents the second first bottom circuit pattern, and so on.

In some embodiments, the number of the first bottom circuit patterns 132a is the same as the number of the first top circuit patterns 136a, and the number of the second bottom circuit patterns 132b is the same as the number of the second top circuit patterns 136b. The number of the first conductive pillars 134a′ is substantially twice the number of the first bottom circuit patterns 132a, and the number of the second conductive pillars 134b′ is substantially twice the number of the second bottom circuit patterns 132b.

In some embodiments, two ends of the first bottom circuit pattern 132a may respectively correspond to a pair of the first conductive pillars 134a′ (or a pair of the first vertical connectors 134a of the middle layers 104a to 104h) and be electrically connected to the pair of the first conductive pillars 134a′ (or the pair of the first vertical connectors 134a of the middle layers 104a to 104h), and two ends of the second bottom circuit pattern 132b may respectively correspond to a pair of the second conductive pillars 134b′ (or a pair of the second vertical connectors 134b of the middle layers 104a to 104h) and be electrically connected to the pair of the second conductive pillars 134b′ (or the pair of the second vertical connectors 134b of the middle layers 104a to 104h). For example, the first pair of the first conductive pillars 134a′(1) respectively correspond to the two ends of the first first bottom circuit pattern 132a(1), the second pair of the first conductive pillars 134a′(2) respectively correspond to the two ends of the second first bottom circuit pattern 132a(2), and so on. Specifically, all the first bottom circuit patterns 132a and the second bottom circuit patterns 132b have first ends E1 and second ends E2. The first end E1 is, for example, close to an outer side of the ring-shaped metal layer 120, and the second end E2 is, for example, close to an inner side of the ring-shaped metal layer 120. The first end E1 of the first first bottom circuit pattern 132a(1) may correspond to the outer conductive pillar of the first pair of the first conductive pillars 134a′(1) (referring to the conductive pillar on the outer side of the ring-shaped metal layer 120 among the first pair of the first conductive pillars 134a′(1)), and the second end E2 of the first first bottom circuit pattern 132a(1) may correspond to the inner conductive pillar of the first pair of the first conductive pillars 134a′(1) (referring to the conductive pillar on the inner side of the ring-shaped metal layer 120 among the first pair of the first conductive pillars 134a′(1)), and so on, which will not be described again here.

In some embodiments, as shown in FIG. 1E, the orthographic projections of the first bottom circuit patterns 132a in the first direction D1 and the orthographic projections of the first top circuit patterns 136a in the first direction D1 are staggered along the second direction D2 to jointly form a Z-shaped orthographic projection shape. Specifically, all the first bottom circuit patterns 132a and all the first top circuit patterns 136a have the first ends E1 and the second ends E2. The first end E1 is, for example, close to the outer side of the ring-shaped metal layer 120, and the second end E2 is, for example, close to the inner side of the ring-shaped metal layer 120. The first end E1 of the N^{th} first top circuit pattern 136a arranged in the second direction D2 corresponds to the first end E1 of the (N+1)^{th} first bottom circuit pattern 132a arranged in the second direction D2, and the second end E2 of the N^{th} first top circuit pattern 136a arranged in the second direction D2 corresponds to the second end E2 of the N^{th} first bottom circuit pattern 132a arranged in the second direction D2. For example, the second end E2 of the first first bottom circuit pattern 132a(1) may correspond to the second end E2 of the first first top circuit pattern 136a(1), so the inner conductive pillar of the first pair of the first conductive pillars 134a′(1) may be connected between the second end E2 of the first first bottom circuit pattern 132a(1) and the second end E2 of the first first top circuit pattern 136a(1). In addition, the first end E1 of the first first top circuit pattern 136a(1) corresponds to the first end E1 of the second first bottom circuit pattern 132a(2), so the outer conductive pillar of the second pair of the first conductive pillars 134a′(2) may be connected between the first end E1 of the first first top circuit pattern 136a(1) and the first end E1 of the second first bottom circuit pattern 132a(2). In this way, the outer conductive pillar of the first pair of the first conductive pillars 134a′(1), the first first bottom circuit pattern 132a(1), the inner conductive pillar of the first pair of the first conductive pillars 134a′(1), and the first first top circuit pattern 136a(1) are sequentially connected to form a first coil structure surrounding the side S1 of the stacked ring-shaped metal layers 120. Similarly, the second end E2 of the second first bottom circuit pattern 132a(2) may correspond to the second end E2 of the second first top circuit pattern 136a(2), so the inner conductive pillar of the second pair of the first conductive pillars 134a′(2) may be connected between the second end E2 of the second first bottom circuit pattern 132a(2) and the second end E2 of the second first top circuit pattern 136a(2). In this way, the outer conductive pillar of the second pair of the first conductive pillars 134a′(2), the second first bottom circuit pattern 132a(2), the inner conductive pillar of the second pair of the first conductive pillars 134a′(2), and the second first top circuit pattern 136a(2) are sequentially connected to form a second coil structure surrounding the stacked ring-shaped metal layers 120, and since the outer conductive pillar of the second pair of the first conductive pillars 134a′(2) is connected between the first first top circuit pattern 136a(1) and the second first bottom circuit pattern 132a(2), the first coil structure and the second coil structure are connected to each other and electrically connected. Based on the above, the above configuration may be repeated to obtain a continuous coil structure (such as including 12 coil structures connected to each other) composed of the first bottom circuit pattern 132a, the first top circuit pattern 136a, and the first conductive pillar 134a′. The coil structure surrounds along the side S1 of the stacked ring-shaped metal layers 120 and may be referred to as a primary side coil structure, thereby forming a first conductive path that surrounds along the side S1 of the stacked ring-shaped metal layers 120. In the embodiment, the primary side coil structure surrounds the side S1 of the ring-shaped metal layers 120 in a counterclockwise direction, but the disclosure is not limited thereto. In other embodiments, the primary side coil structure may be wound in a clockwise direction through adjusting the relative positions of the first bottom circuit pattern 132a, the first top circuit pattern 136a, and the first conductive pillar 134a′.

On the other hand, the orthographic projections of the second bottom circuit patterns 132b in the first direction D1 and the orthographic projections of the second top circuit patterns 136b in the first direction D1 are staggered along the second direction D2 to jointly form the Z-shaped orthographic projection shape. Specifically, similar to the connection manner of the first bottom circuit pattern 132a, the first top circuit pattern 136a, and the first conductive pillar 134a′, the first end E1 of the N^{th} second top circuit pattern 136b arranged in the second direction D2 corresponds to the first end E1 of the (N+1)^{th} second bottom circuit pattern 132b arranged in the second direction D2, and the second end E2 of the N^{th} second top circuit pattern 136b arranged in the second direction D2 corresponds to the second end E2 of the N^{th} second bottom circuit pattern 132b arranged in the second direction D2. For example, the second end E2 of the first second bottom circuit pattern 132b(1) may correspond to the second end E2 of the first second top circuit pattern 136b(1), so the inner conductive pillar of the first pair of the second conductive pillars 134b′(1) may be connected between the second end E2 of the first second bottom circuit pattern 132b(1) and the second end E2 of the first second top circuit pattern 136b(1). In addition, the first end E1 of the first second top circuit pattern 136b(1) corresponds to the first end E1 of the second second bottom circuit pattern 132b(2), so the outer conductive pillar of the second pair of the second conductive pillars 134b′(2) may be connected between the first end E1 of the first second top circuit pattern 136b(1) and the first end E1 of the second second bottom circuit pattern 132b(2). In this way, the outer conductive pillar of the first pair of the second conductive pillars 134b′(1), the first second bottom circuit pattern 132b(1), the inner conductive pillar of the first pair of the second conductive pillars 134b′(1), and the first second top circuit pattern 136b(1) are sequentially connected to form the first coil structure surrounding the side S3 of the stacked ring-shaped metal layers 120. By analogy, the second bottom circuit pattern 132b, the second top circuit pattern 136b, and the second conductive pillar 134b′ may form a continuous coil structure (such as including 9 coil structures connected to each other). The coil structure surrounds along the side S3 of the stacked ring-shaped metal layers 120 and may be referred to as a secondary side coil structure, thereby forming a second conductive path that surrounds along the side S3 of the stacked ring-shaped metal layers 120. In the embodiment, the secondary side coil structure surrounds the side S3 of the ring-shaped metal layers 120 in a counterclockwise direction, but the disclosure is not limited thereto. In other embodiments, the secondary side coil structure may be wound in a clockwise direction through adjusting the relative positions of the second bottom circuit pattern 132b, the second top circuit pattern 136b, and the second conductive pillar 134b′.

In some embodiments, the top circuit layer 136 also includes a first top connecting line 136c and a second top connecting line 136d. The first top connecting line 136c may be electrically connected to the outer conductive pillar of the first pair of the first conductive pillars 134a′(1) to serve as one of multiple external connecting lines of the primary side coil structure. The second top connecting line 136d may be physically and electrically connected to the last one (that is, the twelfth top circuit pattern 136a(12)) of the first top circuit pattern 136a, that is, the second top connecting line 136d may also be regarded as an extension line of the twelfth top circuit pattern 136a(12) to serve as another external connecting line of the primary side coil structure.

In some embodiments, the top circuit layer 136 also includes a third top connecting line 136e and a fourth top connecting line 136f. The third top connecting line 136e may be electrically connected to the outer conductive pillar of the first pair of the second conductive pillars 134b′(1) to serve as one of multiple external connecting lines of the secondary side coil structure. The fourth top connecting line 136f may be physically and electrically connected to the last one (that is, the nineth top circuit pattern 136b(9)) of the second top circuit pattern 136b, that is, the fourth top connecting line 136f may also be regarded as an extension line of the nineth top circuit pattern 136b(9) to serve as another external connecting line of the secondary side coil structure.

In some embodiments, the top insulating layer 110t of the top structure 106 may include multiple openings (not shown) to expose a part of the first top connecting line 136c, a part of the second top connecting line 136d, a part of the third top connecting line 136e, and a part of the fourth top connecting line 136f, so that the exposed parts may serve as contacts cp for external connection.

From another perspective, the transformer 10 may include an insulator 110′, the ring-shaped metal layers 120, a first wire structure 130a, and a second wire structure 130b. The insulator 110′ may include the top insulating layer 110t, multiple insulating layers 110, and the bottom insulating layer 110b that are stacked. The ring-shaped metal layers 120, the first wire structure 130a, and the second wire structure 130b are disposed in the insulator 110′ and are electrically isolated from each other. The ring-shaped metal layers 120 are arranged in the first direction D1 and overlap with each other, and the adjacent ring-shaped metal layers 120 are separated by the insulator 110′. The first wire structure 130a surrounds along one side (for example, the side S1) of the stacked ring-shaped metal layers 120, and the second wire structure 130b surrounds along another side (for example, the side S3) of the stacked ring-shaped metal layers 120. In some embodiments, the first wire structure 130a may include the primary side coil structure composed of the first top circuit patterns 136a, the first conductive pillars 134a′, and the first bottom circuit patterns 132a, wherein the orthographic projections of the first top circuit patterns 136a in the first direction D1 and the orthographic projections of the first bottom circuit patterns 132a in the first direction D1 are staggered along the second direction D2. The second wire structure 130b may include the secondary side coil structure composed of the second top circuit patterns 136b, the second conductive pillars 134b′, and the second bottom circuit patterns 132b, wherein the orthographic projections of the second top circuit patterns 136b in the first direction D1 and the orthographic projections of the second bottom circuit patterns 132b in the first direction D1 are staggered along the second direction D2.

In some embodiments, the first wire structure 130a may also include the first top connecting line 136c and the second top connecting line 136d, which are respectively connected to the two ends of the primary side coil structure. In some embodiments, the second wire structure 130b may also include the third top connecting line 136e and the fourth top connecting line 136f, which are respectively connected to the two ends of the secondary side coil structure.

In some embodiments, a width W of the transformer 10 measured in the third direction D3 may be approximately between 1 m and 0.1 cm. In some embodiments, a length L of the transformer 10 measured in the second direction D2 may be approximately between 1 m and 0.1 cm.

In some embodiments, the material of the ring-shaped metal layer 120 is substantially the same as the materials of the first wire structure 130a and the second wire structure 130b, but the disclosure is not limited thereto. In other embodiments, the material of the ring-shaped metal layer 120 is different from the materials of the first wire structure 130a and the second wire structure 130b.

In some embodiments, the material of the insulator 110′ may include polyimide (PI), benzocyclobutene (BCB), silicon oxide, silicon nitride, a combination thereof, or other suitable insulating materials.

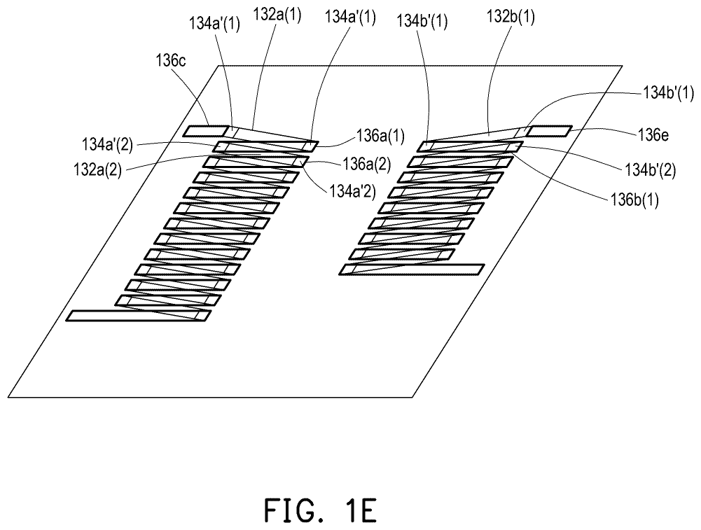

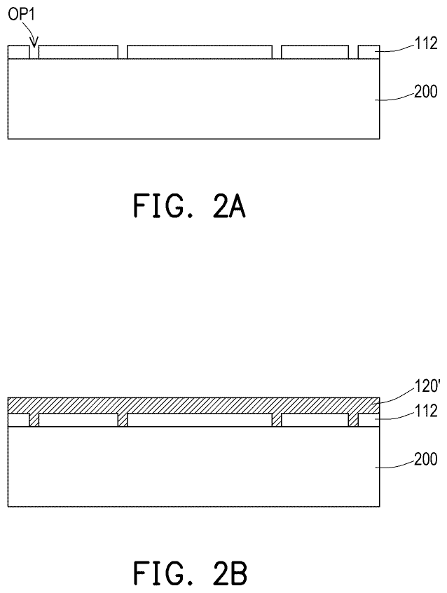

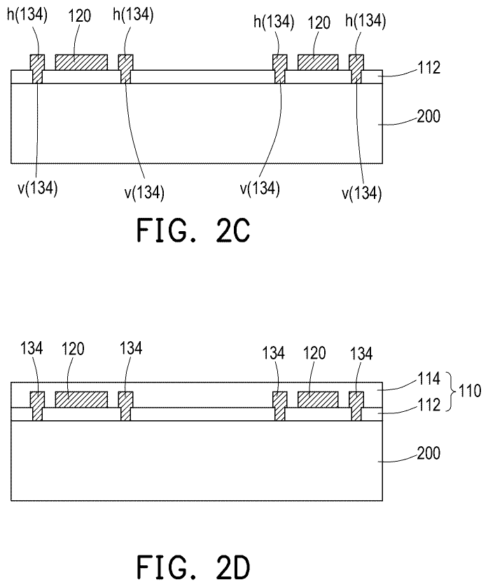

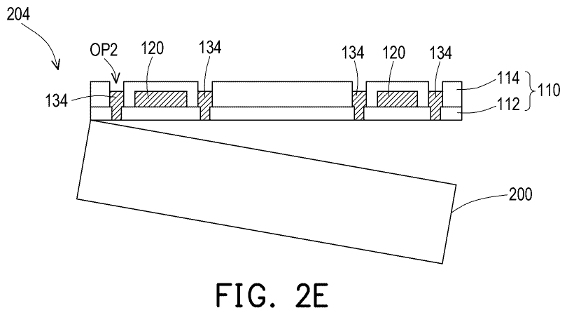

FIG. 2A to FIG. 2E are schematic cross-sectional views of a manufacturing process of a middle layer 204 according to an embodiment of the disclosure. It must be noted here that the embodiment of FIG. 2A to 2E continues to use the reference numerals and some content of the embodiment of FIG. 1A to FIG. 1E, wherein the same or similar reference numerals are adopted to represent the same or similar elements, and the description of the same technical content is omitted. For the description of the omitted part, reference may be made to the foregoing embodiment and will not be described again here.

Please refer to FIG. 2A. A first insulating layer 112 is formed over a carrier 200, wherein the first insulating layer 112 has multiple first openings OP1. For example, an insulating material layer (not shown) may be formed on the carrier 200 through chemical vapor deposition, physical vapor deposition, spin coating, or other suitable deposition processes, and the first openings OP1 are then formed in the insulating material layer using photolithographic etching to form the first insulating layer 112. The carrier 200 may be, for example, a wafer, glass, ceramic, or other suitable materials for supporting structures subsequently formed thereon.

Please refer to FIG. 2B and FIG. 2C. The ring-shaped metal layer 120 is formed over the first insulating layer 112, and the vertical connectors 134 are formed over the first insulating layer 112 and in the first openings OP1. The ring-shaped metal layer 120 is located between the vertical connectors 134. For example, as shown in FIG. 2B, a conductive material layer 120′ may be formed over the first insulating layer 112 and in the first openings OP1. Then, the conductive material layer 120′ may be patterned to form the ring-shaped metal layer 120 over the first insulating layer 112, and form the vertical connectors 134 over the first insulating layer 112 and in the first openings OP1. In some embodiments, the conductive material layer 120′ may be formed through chemical vapor deposition, physical vapor deposition, electroplating, electroless plating, or other suitable deposition processes. In some embodiments, the material of the conductive material layer 120′ may include copper, tungsten, gold, aluminum, silver, titanium, an alloy thereof, a combination thereof, or other suitable conductive materials. In some embodiments, before the conductive material layer 120′ is formed, a barrier layer (not shown), such as including titanium nitride or similar materials, may be formed over the carrier 200 to reduce diffusion of the conductive material into the insulating layer. In some embodiments, the patterning method of the conductive material layer 120′ is, for example, forming a patterned photoresist on the conductive material layer 120′, and performing an etching process using the patterned photoresist as a mask to remove a part of the conductive material layer 120′, and the remaining conductive material layer 120′ is formed into the ring-shaped metal layer 120 and the vertical connectors 134. In other words, the material of the ring-shaped metal layer 120 is substantially the same as the material of the vertical connector 134.

In some embodiments, the vertical connector 134 may include a horizontal portion h and a vertical portion v. The horizontal portion h is located on the first insulating layer 112 and the vertical portion v is located in the first opening OPL. In some embodiments, a top surface of the horizontal portion h of the vertical connector 134 is substantially aligned with a top surface of the ring-shaped metal layer 120. A bottom surface of the vertical portion v of the vertical connector 134 is substantially aligned with a bottom surface of the first insulating layer 112.

Please refer to FIG. 2D. A second insulating layer 114 is formed on the ring-shaped metal layer 120 and the vertical connectors 134 to cover the top surfaces of the ring-shaped metal layer 120 and the vertical connectors 134, wherein the first insulating layer 112 and the second insulating layer 114 jointly form the insulating layer 110. It can be seen that the ring-shaped metal layer 120 and the vertical connectors 134 are embedded in the insulating layer 110 and are electrically isolated from each other through the insulating layer 110.

In some embodiments, the first insulating layer 112 and the second insulating layer 114 may include thermally conductive insulating materials. In some embodiments, each of the materials of the first insulating layer 112 and the second insulating layer 114 may include polyimide (PI), benzocyclobutene (BCB), silicon oxide, silicon nitride, a combination thereof, or other suitable insulating materials. The formation method of the second insulating layer 114 may be similar to the formation method of the first insulating layer 112.

Please refer to FIG. 2E. Multiple second openings OP2 are formed in the second insulating layer 114 to expose the vertical connector 134, so that the vertical connector 134 may be connected to other components during a subsequent process. The formation method of the second opening OP2 may be similar to the formation method of the first opening OP1.

In some embodiments, when performing subsequent processes (for example, a bonding process, a pressing process, etc.), the carrier 200 may be peeled off.

Based on the above, the manufacturing of the middle layer 204 may be roughly completed. In some embodiments, the middle layers 104a to 104h of the transformer 10 may be manufactured through the above process.

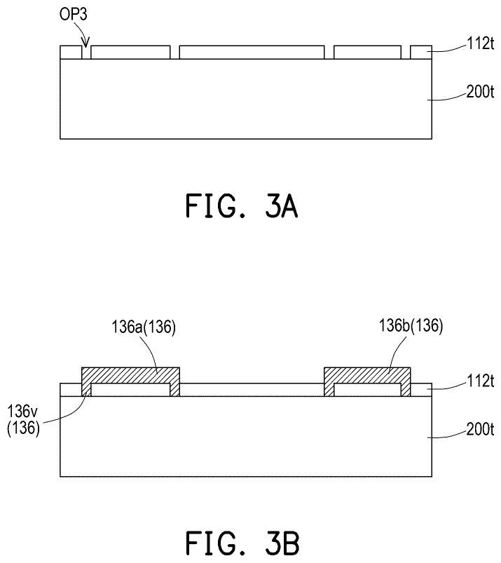

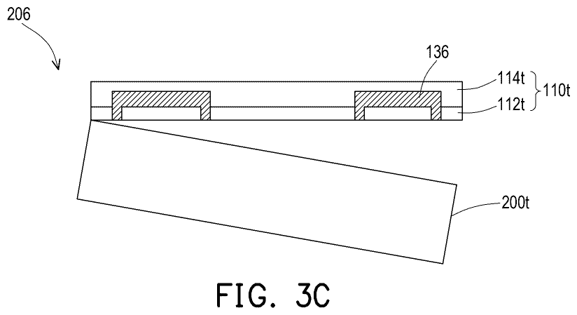

FIG. 3A to FIG. 3C are schematic cross-sectional views of a manufacturing process of a top structure 206 according to an embodiment of the disclosure. It must be noted here that the embodiment of FIG. 3A to FIG. 3C continues to use the reference numerals and some content of the embodiment of FIG. 1A to FIG. 1E, wherein the same or similar reference numerals are adopted to represent the same or similar elements, and the description of the same technical content is omitted. For the description of the omitted part, reference may be made to the foregoing embodiment and will not be described again here.

Please refer to FIG. 3A. A first top insulating layer 112t is formed on a carrier 200t, wherein the first top insulating layer 112t has multiple top openings OP3. The carrier 200t may be similar to the carrier 200. The material and the formation method of the first top insulating layer 112t are similar to the first insulating layer 112, and the formation method of the top opening OP3 is similar to the first opening OP1.

Please refer to FIG. 3B. The top circuit layer 136 is formed over the first top insulating layer 112t. For example, a conductive material layer (not shown) may be formed over the first top insulating layer 112t first. Then, the conductive material layer is patterned to form the top circuit layer 136 over the first top insulating layer 112t and in the first opening OP1. In some embodiments, the top circuit layer 136 may include the first top circuit patterns 136a and the second top circuit patterns 136b located over the first top insulating layer 112t and multiple top contacts 136v located in the top openings OP3. The top contacts 136v may correspond to the two ends of the first top circuit pattern 136a and/or the two ends of the second top circuit pattern 136b to be connected to other components during a subsequent process.

Please refer to FIG. 3C. A second top insulating layer 114t is formed on the top circuit layer 136 to cover a top surface of the top circuit layer 136, wherein the first top insulating layer 112t and the second top insulating layer 114t jointly form the top insulating layer 110t. It can be seen that the top circuit layer 136 is embedded in the top insulating layer 110t. The material and the formation method of the second top insulating layer 114t are similar to the second insulating layer 114.

In some embodiments, an opening (not shown) may be formed in the second top insulating layer 114t to expose a part of the top circuit layer 136, such as a contact cp as shown in FIG. 1A, to provide a contact for external connection.

In some embodiments, when performing subsequent processes (for example, a bonding process, a pressing process, etc.), the carrier 200t may be peeled off.

Based on the above, the manufacturing of the top structure 206 may be roughly completed. In some embodiments, the top structure 106 of the transformer 10 may be manufactured through the above process.

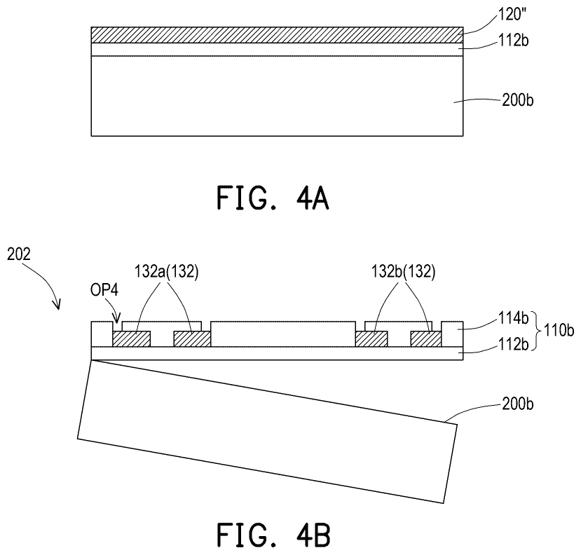

FIG. 4A and FIG. 4B are schematic cross-sectional views of a manufacturing process of a bottom structure 202 according to an embodiment of the disclosure. It must be noted here that the embodiment of FIG. 4A and FIG. 4B continues to use the reference numerals and some content of the embodiment of FIG. 1A to 1E, wherein the same or similar reference numerals are adopted to represent the same or similar elements, and the description of the same technical content is omitted. For the description of the omitted part, reference may be made to the foregoing embodiment and will not be described again here.

Please refer to FIG. 4A. A first bottom insulating layer 112b is formed over a carrier 200b, and a conductive material layer 120″ is then formed over the first bottom insulating layer 112b. The carrier 200b may be similar to the carrier 200. The materials and the formation methods of the first bottom insulating layer 112b and the conductive material layer 120″ may be similar to the first insulating layer 112 and the conductive material layer 120′.

Please refer to FIG. 4B. The conductive material layer 120″ is patterned to form the bottom circuit layer 132 over the first bottom insulating layer 112b. In some embodiments, the bottom circuit layer 132 may include the first bottom circuit patterns 132a and the second bottom circuit patterns 132b. Then, a second bottom insulating layer 114b is formed on the bottom circuit layer 132 to cover a top surface of the bottom circuit layer 132. The first bottom insulating layer 112b and the second bottom insulating layer 114b jointly form the bottom insulating layer 110b. It can be seen that the bottom circuit layer 132 is embedded in the bottom insulating layer 110b. The material and the formation method of the second bottom insulating layer 114b may be similar to the second insulating layer 114.

Afterwards, multiple bottom openings OP4 are formed in the second bottom insulating layer 110b to expose a part of the bottom circuit layer 132 and may be connected to other components during a subsequent process. In some embodiments, the bottom openings OP4 may expose the two ends of the first bottom circuit patterns 132a and the two ends of the second bottom circuit patterns 132b. The formation method of the bottom opening OP4 may be similar to the formation method of the first opening OP1.

In some embodiments, when performing subsequent processes (for example, a bonding process, a pressing process, etc.), the carrier 200b may be peeled off.

Based on the above, the manufacturing of the bottom structure 202 may be roughly completed. In some embodiments, the bottom structure 102 of the transformer 10 may be manufactured through the above process.

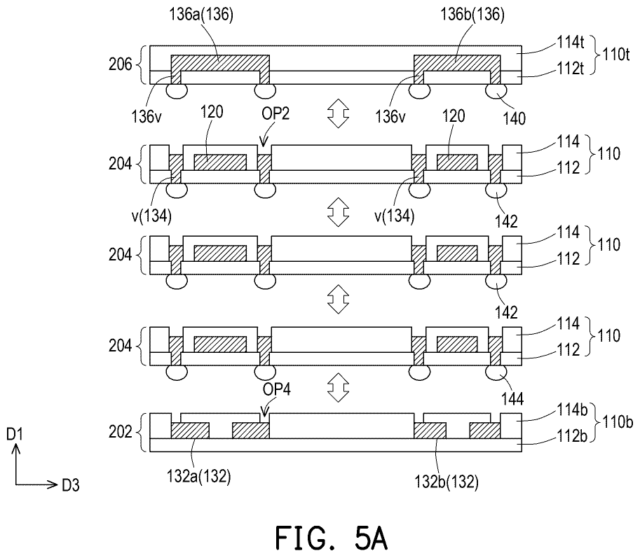

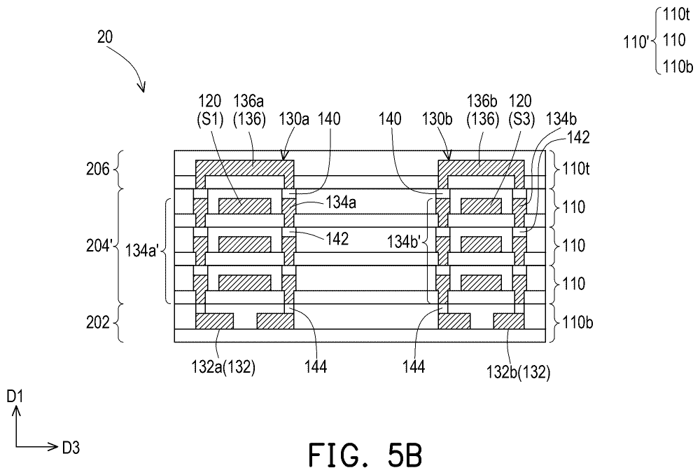

FIG. 5A to FIG. 5B are schematic cross-sectional views of a manufacturing process of a transformer 20 according to an embodiment of the disclosure. It must be noted here that the embodiment of FIG. 5A to FIG. 5B continues to use the reference numerals and some content of the embodiments of FIG. 2A to 2E, FIG. 3A to FIG. 3C, and FIG. 4A and FIG. 4B, wherein the same or similar reference numerals are adopted to represent the same or similar elements, and the description of the same technical content is omitted. For the description of the omitted part, reference may be made to the foregoing embodiments and will not be described again here.

Please refer to FIG. 5A. The bottom structure 202, the middle layers 204, and the top structure 206 are provided. The bottom structure 202, the middle layer 204, and the top structure 206 may be manufactured according to the processes of FIG. 4A and FIG. 4B, FIG. 2A to FIG. 2E, and FIG. 3A to FIG. 3C. In the embodiment, 3 middle layers 204 are illustratively provided, which is not intended to limit the disclosure. The number of the middle layers 204 may be adjusted according to actual requirements.

Please refer to FIG. 5A and FIG. 5B. The bottom structure 202, the middle layers 204, and the top structure 206 are sequentially stacked and bonded, so that the middle layers 204 are located between the bottom structure 202 and the top structure 206. The ring-shaped metal layers 120 of the middle layers 204 overlap with each other, and the vertical connectors 134 of the middle layers 204 overlap with each other. In some embodiments, the bottom structure 202, the middle layers 204, and the top structure 206 may be bonded under one or more pressing operations through a pressing process, so that the top circuit layer 136 of the top structure 206 and the bottom circuit layer 132 of the bottom structure 202 are electrically connected to each other through the vertical connectors 134 of the middle layers 204.

In some embodiments, the top circuit layer 136 of the top structure 206 may be bonded and electrically connected to the vertical connector 134 corresponding to the topmost layer among the middle layers 204 through a third conductive connector 140. For example, the third conductive connector 140 may be formed on the top contact 136v of the top structure 206, and the top contact 136v of the top structure 206 may be aligned with the vertical connector 134 of the topmost layer among the middle layers 204. For example, the third conductive connector 140 of the top structure 206 is disposed in the second opening OP2 of the second insulating layer 114 of the topmost layer among the middle layers 204. In this way, the top contact 136v of the top structure 206 and the vertical connector 134 of the topmost layer among the middle layers 204 may be bonded through the third conductive connector 140. In some embodiments, a dielectric-to-dielectric bonding process may be performed on the first top insulating layer 112t of the top structure 206 and the second insulating layer 114 of the topmost layer among the middle layers 204.

In some embodiments, the third conductive connector 140 may include a solder ball, a micro bump, or other suitable conductive connectors. The material of the solder ball may include tin, an alloy thereof, or other suitable solder materials. The material of the micro bump may include copper, aluminum, gold, silver, tungsten, titanium, an alloy thereof, or other suitable conductive materials. In some embodiments, when the third conductive connector 140 is a solder ball, the top contact 136v may be bonded to the vertical connector 134 through executing a reflow process. When the third conductive connector 140 is a micro bump, the top contact 136v may be bonded to the vertical connector 134 through executing a metal-to-metal bonding process.

In some embodiments, the vertical connectors 134 corresponding to the adjacent middle layers 204 may be bonded and electrically connected to each other through the first conductive connector 142. For example, the first conductive connector 142 may be formed on the vertical portion v of the vertical connector 134 of the middle layer 204, and the first conductive connector 142 may be aligned with the vertical connector 134 of the middle layer 204 below. For example, the first conductive connector 142 may be disposed in the second opening OP2 of the second insulating layer 114 of the middle layer 204 below. In this way, the vertical connector 134 of the middle layer 204 may be bonded to the vertical connector 134 of the middle layer 204 below through the first conductive connector 142. In some embodiments, a dielectric-to-dielectric bonding process may be performed on the first insulating layer 112 of the middle layer 204 and the second insulating layer 114 of the middle layer 204 below. The above steps may be repeated to bond the middle layers 204 to form a middle structure 204′.

In some embodiments, an additional conductive connector may be formed in the second opening OP2 of the second insulating layer 114 of the middle layer 204 below to facilitate bonding with the middle layer 204 above. The additional conductive connector and the first conductive connector 142 may be similar to the third conductive connector 140.

In some embodiments, the bottom circuit layer 132 of the bottom structure 202 may be bonded and electrically connected to the vertical connector 134 corresponding to the bottommost layer among the middle layers 204 through a second conductive connector 144. For example, the second conductive connector 144 may be formed on the vertical portion v of the vertical connector 134 of the bottommost layer among the middle layers 204, and the second conductive connector 144 may be aligned with the bottom opening OP4 of the second bottom insulating layer 114b of the bottom structure 202, that is, aligned with the two ends of the first bottom circuit pattern 132a and the second bottom circuit pattern 132b. In this way, the vertical connector 134 of the bottommost layer among the middle layers 204 and the bottom circuit layer 132 of the bottom structure 202 may be bonded through the second conductive connector 144. In some embodiments, a dielectric-to-dielectric bonding process may be performed on the first insulating layer 112 of the bottommost layer among the middle layers 204 and the second bottom insulating layer 114b of the bottom structure 202.

In some embodiments, an additional conductive connector may be formed in the bottom opening OP4 of the second bottom insulating layer 114b of the bottom structure 202 to facilitate bonding with the bottommost layer among the middle layers 204. The additional conductive connector and the second conductive connector 144 may be similar to the third conductive connector 140.

Based on the above, the manufacturing of the transformer 20 may be roughly completed. The transformer 20 respectively manufactures the bottom structure 202, the middle layer 204, and the top structure 206 using a semiconductor manufacturing method. Then, an appropriate number of middle layers is selected according to requirements. The bottom structure 202, the middle layers 204, and the top structure 206 are bonded together to form the transformer. 20. In this way, the transformer 20 may be manufactured efficiently and flexibly, and the size of the transformer 20 may be reduced based on a semiconductor manufacturing process.

The schematic three-dimensional view of the transformer 20 may be similar to FIG. 1A, and FIG. 5B may be a schematic cross-sectional view of an embodiment along a sectional line A-A′ of FIG. 1A.

Please refer to FIG. 5B. The transformer 20 may include the insulator 110′, the ring-shaped metal layers 120, the first wire structure 130a, and the second wire structure 130b. The insulator 110′ may include the top insulating layer 110t, the insulating layers 110, and the bottom insulating layer 110b that are stacked. The ring-shaped metal layers 120, the first wire structure 130a, and the second wire structure 130b are disposed in the insulator 110′ and are electrically isolated from each other. The ring-shaped metal layers 120 are arranged in the first direction D1 and overlap with each other, and the adjacent ring-shaped metal layers 120 are separated by the insulator 110′. The first wire structure 130a surrounds along one side (for example, the side S1) of the stacked ring-shaped metal layers 120, and the second wire structure 130b surrounds along another side (for example, the side S3) of the stacked ring-shaped metal layers 120.

In some embodiments, the first wire structure 130a may include the primary side coil structure composed of the first top circuit patterns 136a, the first conductive pillars 134a′, and the first bottom circuit patterns 132a, wherein the orthographic projections of the first top circuit patterns 136a in the first direction D1 and the orthographic projections of the first bottom circuit patterns 132a in the first direction D1 are staggered along the second direction D2. In some embodiments, the first conductive pillar 134a′ may include first vertical connectors 134a and the first conductive connectors 142 that are staggered and stacked. In some embodiments, the first conductive pillar 134a′ may be connected to the first top circuit pattern 136a through the third conductive connector 140 and the top contact 136v. In some embodiments, the first conductive pillar 134a′ may be connected to the first bottom circuit pattern 132a through the second conductive connector 144.

In some embodiments, the material of the first vertical connector 134a is different from the material of the first conductive connector 142. However, the disclosure is not limited thereto. In other embodiments, the material of the first vertical connector 134a is the same as the material of the first conductive connector 142.

In some embodiments, the second wire structure 130b may include the secondary side coil structure composed of the second top circuit patterns 136b, the second conductive pillars 134b′, and the second bottom circuit patterns 132b, wherein the orthographic projections of the second top circuit patterns 136b in the first direction D1 and the orthographic projections of the second bottom circuit patterns 132b in the first direction D1 are staggered along the second direction D2. In some embodiments, the second conductive pillar 134b′ may include second vertical connectors 134b and the first conductive connectors 142 that are staggered and stacked. In some embodiments, the second conductive pillar 134b′ may be connected to the second top circuit pattern 136b through the third conductive connector 140 and the top contact 136v. In some embodiments, the second conductive pillar 134b′ may be connected to the second bottom circuit pattern 132b through the second conductive connector 144.

In some embodiments, the materials of the second vertical connector 134b and the first conductive connector 142 are different. However, the disclosure is not limited thereto. In other embodiments, the material of the second vertical connector 134b is the same as the material of the first conductive connector 142.

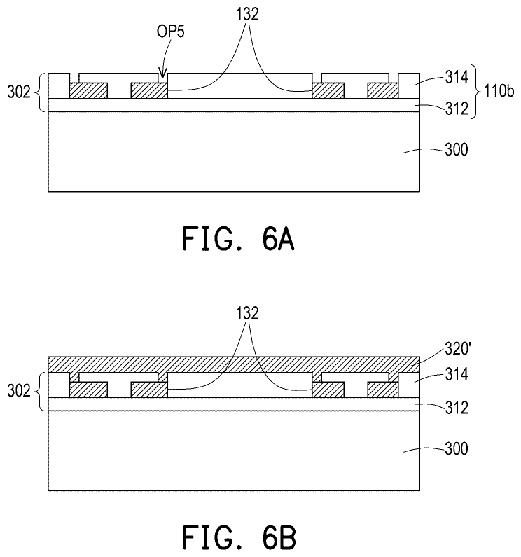

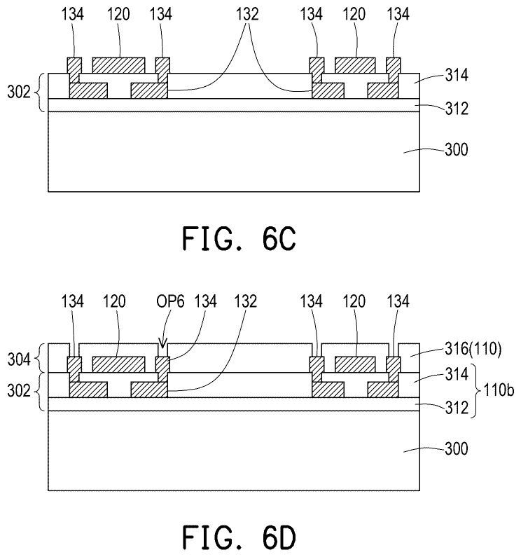

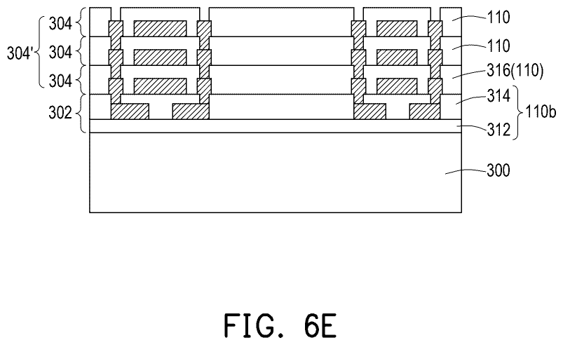

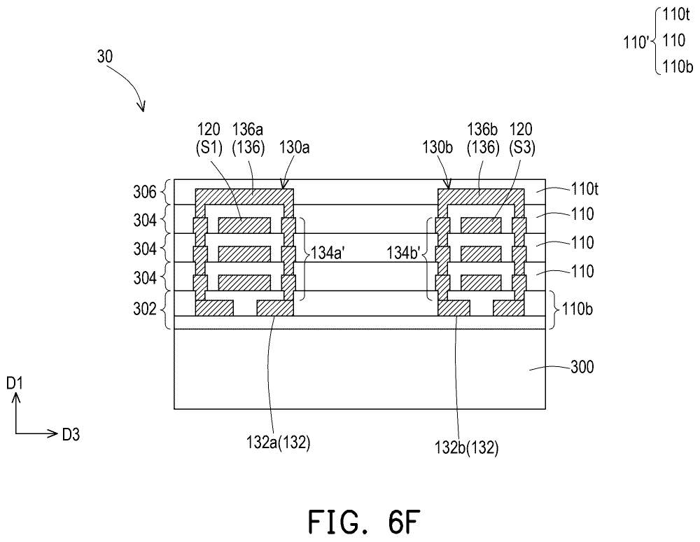

FIG. 6A to FIG. 6F are schematic cross-sectional views of a manufacturing process of a transformer 30 according to an embodiment of the disclosure. It must be noted here that the embodiment of FIG. 6A to FIG. 6F continues to use the reference numerals and some content of the embodiment of FIG. 1A to 1E, wherein the same or similar reference numerals are adopted to represent the same or similar elements, and the description of the same technical content is omitted. For the description of the omitted part, reference may be made to the foregoing embodiment and will not be described again here.

Please refer to FIG. 6A. A first insulating layer 312 is formed over a carrier 300, the bottom circuit layer 132 is formed on the first insulating layer 312, and a second insulating layer 314 is then formed on the bottom circuit layer 132. After that, multiple bottom openings OP5 are formed in the second insulating layer 314 to expose a part of the bottom circuit layer 132. The above process is similar to the process described in FIG. 4A and FIG. 4B and will not be described again. In some embodiments, the bottom circuit layer 132, the first insulating layer 312, and the second insulating layer 314 may form a bottom structure 302. In some embodiments, the first insulating layer 312 and the second insulating layer 314 may be regarded as the bottom insulating layer 110b of the bottom structure 302, and the bottom circuit layer 132 is embedded in the bottom insulating layer 110b.

Please refer to FIG. 6B. A conductive material layer 320′ is formed on the second insulating layer 314 and in the bottom opening OP5. Thereafter, as shown in FIG. 6C, the conductive material layer 320′ is patterned to form the ring-shaped metal layer 120 on the second insulating layer 314, and form the vertical connector 134 on the second insulating layer 314 and in the bottom opening OP5. Afterwards, as shown in FIG. 6D, a third insulating layer 316 is formed on the ring-shaped metal layer 120 and the vertical connector 134. The above process is similar to the process described in FIG. 2B to FIG. 2D and will not be described again. In some embodiments, the ring-shaped metal layer 120, the vertical connector 134, and the third insulating layer 316 may form a middle layer 304. In some embodiments, the third insulating layer 316 may be regarded as the insulating layer 110 of the middle layer 304, and the ring-shaped metal layer 120 is embedded in the insulating layer 110. The ring-shaped metal layer 120 is enclosed by the insulating layer 110 and the bottom insulating layer 110b of the bottom structure 302. In some embodiments, the vertical connector 134 of the middle layer 304 is located in the insulating layer 110 of the middle layer 304 and also extends through a part of the bottom insulating layer 110b of the bottom structure 302 to be physically and electrically connected to the bottom circuit layer 132, that is, the vertical connector 134 of the middle layer 304 directly contacts the bottom circuit layer 132.

Please refer to FIG. 6D. Multiple opening OP6 are formed in the third insulating layer 316 to expose the vertical connector 134, similar to the process described in FIG. 2E.

Please refer to FIG. 6E. The process of FIG. 6B to FIG. 6D may be repeated to form multiple middle layers 304 on the bottom structure 302. The middle layers 304 that are stacked and connected may form a middle structure 304′. The vertical connector 134 of the middle layer 304 and the corresponding vertical connector 134 of the adjacent middle layer 304 are physically and electrically connected to each other, that is, the vertical connector 134 of the middle layer 304 may directly contact the corresponding vertical connector 134 of the adjacent middle layer 304. The ring-shaped metal layer 120 of the middle layer 304 is enclosed by the insulating layer 110 and the insulating layer 110 of the adjacent middle layer 304. In the embodiment, three middle layers 304 are illustrated as an example, which is not intended to limit the disclosure. The middle layers 304 may be adjusted according to actual requirements.

Please refer to FIG. 6F. The top circuit layer 136 is formed on the insulating layer 110 of the topmost layer among the middle layers 304 and the opening thereof. A part of the top circuit layer 136 (that is, the top circuit layer 136 located in the opening of the insulating layer 110 of the topmost layer among the middle layers 304) may extend through the insulating layer 110 of the topmost layer among the middle layers 304 to be physically and electrically connected to the vertical connector 134 of the topmost layer among the middle layers 304, that is, the top circuit layer 136 may directly contact the vertical connector 134 of the topmost layer among the middle layers 304. Then, the top insulating layer 110t is formed on the top circuit layer 136. The above process is similar to the process described in FIG. 3B and FIG. 3C and will not be described again. In some embodiments, the top circuit layer 136 and the top insulating layer 110t may form a top structure 306.

In some embodiments, the carrier 300 may be peeled off. In other embodiments, the carrier 300 may not be peeled off. For example, the carrier 300 may be a device substrate, a circuit board, or other suitable substrates and has devices such as electronic elements and circuits disposed thereon or therein, and the transformer 30 may be manufactured during the manufacturing process of the devices of the carrier 300 to be integrated together with the devices on the carrier 300.

Based on the above, the manufacturing of the transformer 30 may be roughly completed. The transformer 30 may be manufactured by sequentially stacking layers one by one using a semiconductor manufacturing process, which may be integrated together with the manufacturing of other devices in the semiconductor manufacturing process, thereby effectively utilizing space and reducing the size of the transformer 30.

The schematic three-dimensional view of the transformer 30 may be similar to FIG. 1A, and FIG. 6F may be a schematic cross-sectional view of an embodiment along the sectional line A-A′ of FIG. 1A. Please refer to FIG. 6F. The transformer 30 is similar to the transformer 20. The main difference is that the first conductive pillar 134a′ in the first wire structure 130a of the transformer 30 is composed of the first vertical connectors 134a directly connected, and the second conductive pillar 134b′ in the second wire structure 130b is composed of the second vertical connectors 134b directly connected. In some embodiments, each of the first vertical connectors 134a and the second vertical connectors 134b may include the horizontal portion h and the vertical portion v (as shown in FIG. 2C). The horizontal portion h is located on the vertical portion v. The width of the horizontal portion h may be greater than or equal to the width of the vertical portion v.

In summary, the transformer of the disclosure is manufactured through the semiconductor manufacturing method, which can effectively reduce the size thereof to form an ultra-thin transformer, thereby facilitating application in small-sized products. In addition, the transformer of the disclosure may be easily integrated together with a semiconductor device, which can be efficiently applied in terms of process flow and space.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A manufacturing method of a transformer, comprising:
forming a plurality of middle layers, wherein each of the middle layers comprises:
an insulating layer;
a ring-shaped metal layer, embedded in the insulating layer; and
a plurality of vertical connectors, disposed in the insulating layer and disposed along an inner side and an outer side of the ring-shaped metal layer, wherein the insulating layer electrically isolates the vertical connectors from the ring-shaped metal layer;
forming a top structure, wherein the top structure comprises a top circuit layer embedded in a top insulating layer;
forming a bottom structure, wherein the bottom structure comprises a bottom circuit layer embedded in a bottom insulating layer;
sequentially stacking the bottom structure, the middle layers, and the top structure in a first direction, wherein the ring-shaped metal layers of the middle layers overlap with each other, and the vertical connectors of the middle layers overlap with each other; and
bonding the bottom structure, the middle layers, and the top structure, wherein the top circuit layer and the bottom circuit layer are electrically connected to each other through the vertical connectors of the middle layers.

2. The manufacturing method of the transformer according to claim 1, wherein the vertical connectors of each of the middle layers comprise:
a plurality of first vertical connectors, located in the insulating layer and disposed in pairs on two sides of a first side of the ring-shaped metal layer; and
a plurality of second vertical connectors, located in the insulating layer and disposed in pairs on two sides of a second side of the ring-shaped metal layer, wherein the second side is opposite to the first side.

3. The manufacturing method of the transformer according to claim 2, wherein the top circuit layer of the top structure comprises a plurality of first top circuit patterns and a plurality of second top circuit patterns, and the bottom circuit layer of the bottom structure comprises a plurality of first bottom circuit patterns and a plurality of second bottom circuit patterns,
when sequentially stacking the bottom structure, the middle layers, and the top structure, the first top circuit patterns and the first bottom circuit patterns correspond to the first side of the ring-shaped metal layer, and the second top circuit patterns and the second bottom circuit patterns correspond to the second side of the ring-shaped metal layer.

4. The manufacturing method of the transformer according to claim 3, wherein the first vertical connectors of each of the middle layers correspond to two ends of each of the first bottom circuit patterns, and the second vertical connectors of each of the middle layers correspond to two ends of each of the second bottom circuit patterns.

5. The manufacturing method of the transformer according to claim 3, wherein the first top circuit patterns and the first bottom circuit patterns are electrically connected to each other through the first vertical connectors of the middle layers to form a first conductive path that surrounds along the first side of the ring-shaped metal layer, and the second top circuit patterns and the second bottom circuit patterns are electrically connected to each other through the second vertical connectors of the middle layers to form a second conductive path that surrounds along the second side of the ring-shaped metal layer.

6. The manufacturing method of the transformer according to claim 3, wherein when sequentially stacking the bottom structure, the middle layers, and the top structure, a first end of an N^{th} first top circuit pattern arranged in a second direction corresponds to a first end of a (N+1)^{th} first bottom circuit pattern arranged in the second direction, and a second end of the N^{th} first top circuit pattern arranged in the second direction corresponds to a second end of an N^{th} first bottom circuit pattern arranged in the second direction, wherein the first end refers to an end close to the outer side of the ring-shaped metal layer, the second end refers to an end close to the inner side of the ring-shaped metal layer, and N is a positive integer.

7. The manufacturing method of the transformer according to claim 1, wherein the step of forming each of the middle layers comprises:
forming a first insulating layer, wherein the first insulating layer has a plurality of first openings;
forming the ring-shaped metal layer over the first insulating layer;
forming the vertical connectors over the first insulating layer and in the first openings;
forming a second insulating layer on the ring-shaped metal layer and the vertical connectors to cover top surfaces of the ring-shaped metal layer and the vertical connectors, wherein the first insulating layer and the second insulating layer form the insulating layer; and
forming a plurality of second openings in the second insulating layer to expose the vertical connectors.

8. The manufacturing method of the transformer according to claim 2, wherein the step of forming the top structure comprises:
forming a first top insulating layer, wherein the first top insulating layer has a plurality of top openings;
forming a conductive material layer over the first top insulating layer;
patterning the conductive material layer to form the top circuit layer over the first top insulating layer and in the top openings, wherein the top circuit layer comprises a top circuit pattern located over the first top insulating layer and a plurality of top contacts located in the top openings, and the top contacts correspond to two ends of the top circuit pattern; and
forming a second top insulating layer on the top circuit layer.

9. The manufacturing method of the transformer according to claim 1, wherein the step of forming the bottom structure comprises:
forming a first bottom insulating layer;
forming a conductive material layer over the first bottom insulating layer;
patterning the conductive material layer to form the bottom circuit layer over the first bottom insulating layer, wherein the bottom circuit layer comprises a plurality of bottom circuit patterns;
forming a second bottom insulating layer on the bottom circuit layer; and
forming a plurality of bottom openings in the second bottom insulating layer to expose two ends of each of the bottom circuit patterns.

10. The manufacturing method of the transformer according to claim 1, wherein a method of bonding the bottom structure, the middle layers, and the top structure comprises:
bonding and electrically connecting the vertical connectors corresponding to the adjacent middle layers through a first conductive connector;
bonding and electrically connecting the bottom circuit layer of the bottom structure and the vertical connectors corresponding to a bottommost layer among the middle layers through a second conductive connector; and
bonding and electrically connecting the top circuit layer of the top structure and the vertical connectors corresponding to a topmost layer among the middle layers through a third conductive connector.

11. The manufacturing method of the transformer according to claim 10, wherein the first conductive connector, the second conductive connector, and the third conductive connector comprise solder balls or micro bumps.

12. The manufacturing method of the transformer according to claim 1, wherein after bonding the bottom structure, the middle layers, and the top structure, the vertical connectors of a bottommost layer among the middle layers extend through a part of the bottom insulating layer of the bottom structure to be physically and electrically connected to the bottom circuit layer of the bottom structure, and a part of the top circuit layer of the top structure extends through the insulating layer of a topmost layer among the middle layers to be physically and electrically connected to the vertical connectors of the topmost layer among the middle layers.

13. A manufacturing method of a transformer, comprising:
forming a first insulating layer over a carrier;
forming a bottom circuit layer on the first insulating layer, wherein the bottom circuit layer comprises a plurality of first bottom circuit patterns and a plurality of second bottom circuit patterns;
forming a second insulating layer on the bottom circuit layer;
forming a middle layer over the second insulating layer, wherein the middle layer comprises:
an insulating layer;
a ring-shaped metal layer, embedded in the insulating layer;
a plurality of first vertical connectors, disposed in the insulating layer and disposed along an inner side and an outer side of a first side of the ring-shaped metal layer; and
a plurality of second vertical connectors, disposed in the insulating layer and disposed along an inner side and an outer side of a second side of the ring-shaped metal layer, wherein the second side is opposite to the first side;
forming a top circuit layer over the middle layer, wherein the top circuit layer comprises a plurality of first top circuit patterns and a plurality of second top circuit patterns,
wherein the first top circuit patterns and the first bottom circuit patterns are electrically connected to each other through the first vertical connectors of the middle layer to form a first conductive path that surrounds along the first side of the ring-shaped metal layer, and the second top circuit patterns and the second bottom circuit patterns are electrically connected to each other through the second vertical connectors of the middle layer to form a second conductive path that surrounds along the second side of the ring-shaped metal layer.

14. The manufacturing method of the transformer according to claim 13, wherein the top circuit layer extends through the insulating layer of the middle layer to directly contact the first vertical connectors or the second vertical connectors of the middle layer.

15. The manufacturing method of the transformer according to claim 13, wherein the first vertical connectors or the second vertical connectors of the middle layer extend through the second insulating layer to directly contact the bottom circuit layer.

16. A transformer, comprising:
a bottom structure, comprising a bottom circuit layer embedded in a bottom insulating layer;
a top structure, disposed on the bottom structure, wherein the top structure comprises a top circuit layer embedded in a top insulating layer; and
a middle structure, disposed between the bottom structure and the top structure, where the middle structure comprises:
an insulating layer;
a plurality of ring-shaped metal layers, stacked on each other in a first direction and disposed in the insulating layer; and
a plurality of conductive pillars, disposed in the insulating layer and disposed on an inner side and an outer side of the stacked ring-shaped metal layers, wherein the insulating layer electrically isolates the conductive pillars from the ring-shaped metal layers,
wherein the top circuit layer and the bottom circuit layer are electrically connected through the conductive pillars of the middle structure.

17. The transformer according to claim 16, wherein the conductive pillars comprise:
a plurality of the first conductive pillars, located in the insulating layer and disposed in pairs on two sides of a first side of the stacked ring-shaped metal layers; and
a plurality of the second conductive pillars, located in the insulating layer and disposed in pairs on two sides of a second side of the stacked ring-shaped metal layers, wherein the second side is opposite to the first side.

18. The transformer according to claim 17, wherein the top circuit layer of the top structure comprises a plurality of first top circuit patterns and a plurality of second top circuit patterns, and the bottom circuit layer of the bottom structure comprises a plurality of first bottom circuit patterns and a plurality of second bottom circuit patterns,
the first top circuit patterns and the first bottom circuit patterns correspond to the first side of the stacked ring-shaped metal layers, and the second top circuit patterns and the second bottom circuit patterns correspond to the second side of the stacked ring-shaped metal layers,
wherein orthographic projections of the first top circuit patterns in the first direction and orthographic projections of the first bottom circuit patterns in the first direction are staggered along a second direction.

19. The transformer according to claim 16, wherein each of the conductive pillars comprises vertical connectors and conductive connectors that are staggered and stacked in the first direction, and a material of the vertical connector is different from a material of the conductive connector.

20. The transformer according to claim 19, wherein the material of the vertical connector is the same as a material of the ring-shaped metal layers.
